(19) United States
(12) Patent Application Publication
(10) Pub. No.: US 2007/0239577 A1
(43) Pub. Date: Oct. 11, 2007

(54) Reference data utility

(75) Inventors: Allan D. Grody, New York, NY (US); Richard Robert Tinervin, Hilton Head Island, SC (US)

Correspondence Address: FEDERAL RESEARCH, 1023 15TH STREET, NW, SUITE 401, WASHINGTON, DC, 20005, US

(73) Assignee: FINANCIAL INTERGROUP HOLDINGS LTD

(21) Appl. No.: 11/544,570

(22) Filed: Oct. 10, 2006

Related U.S. Application Data
(60) Provisional application No. 60/726,984, filed on Oct. 14, 2005.

(51) Int. Cl. G06Q 40/00

(52) U.S. Cl. 705/35

(57) ABSTRACT

A Reference Data Utility is provided comprising a method and apparatus for matching, clearing and settling financial transaction reference data. Such method and apparatus includes data communication devices coupled to data storage devices further comprising a data processing system and method for receiving, identifying, selecting, matching, standardizing, organizing, and distributing financial services reference data while mitigating the risk of faulty reference data within the global financial payment and collateral matching mechanism The data communication devices communicates with originating sources of reference data and with supply chain participants in the global financial transaction, matching, clearing, payment and settlement networks. Such participants and sources of reference data include exchanges, clearing and depository facilities, vendors, aggregators, national numbering associations, broker-dealers, asset managers and custodians, amongst others. The data storage devices' store a plurality of reference data and communicates with the data communications devices. The method and apparatus for matching, clearing and settling financial transaction reference data further comprises methods for identifying, selecting, standardizing, and otherwise mitigating the risk of financial transactions which might otherwise fail to be matched at time of payment and/or collateral settlement because of faulty reference data.

### FIELD OF THE INVENTION

This invention relates to a method and apparatus for matching, clearing and settling reference data. More particularly, this invention relates to a method and apparatus for mitigating the risk of financial transactions which might otherwise fail to be matched at time of payment and/or collateral settlement because of faulty reference data.

### BACKGROUND OF THE INVENTION

Financial transactions, which increasingly are exclusively information based, are represented as a series of data elements that collectively represent their unique unalterable attributes, referred to as static data; their occasional adjustments, as in corporate events or changes of ownership; and their variable transaction components such as traded date, quantity and price. The unalterable characteristics and occasional adjustments, collectively termed reference data, uniquely identifies the product (security number and market), its unique structure (financial attributes), its manufacturer (counterparty, dealer or exchange), its delivery point (delivery or settlement instructions), its valuation price (closing or settlement price), its currency, and its expected delivery time. Analogous to specifications and delivery instructions for manufactured products, reference data also defines the products' changing specifications (corporate actions) and seasonal incentives or promotions (dividends, capital distributions and interest). However, unlike manufactured product, the completion of a transaction (acceptance and payment) is not done through manual inspection and/or bar code scanning, but rather is attempted increasingly by automated means either through direct counterparty interaction, through agent's representing counterparties, and through direct counterparty and/or counterparty agent's participation in industry-wide payment and collateral matching, clearance and settlement systems.

Reference data, which represents 70% of the data content of a financial transaction, should be consistent across each financial transaction's life cycle and throughout its supply chain. When reference data that should be identical is not, it causes miscalculated values, misidentified products, and involvement with erroneous supply chain partners (counterparties). The problem, simply stated is that each financial institution or supply chain participant has independently sourced, stored and applied reference data to their own copy(s) of their master inventory and counterparty data bases. When this is applied to the variable components of a financial transaction (i.e. traded date, quantity and transaction price), and an attempt made to match, identically, the details sent by the counterparty in order to accept and pay for the transaction, significant failures in matching occurs. These individual transaction failures cause monetary loss, higher labor costs, and the potential for systemic failure. Reference data mismatches have recently been brought to the fore as the leading cause of failed transactions, thwarting industry-wide straight-through-processing (STP) initiatives and, thus, STP's goal of shortened settlement cycles and reduced transaction default risk.

The SIA (Securities Industry Association) has identified ten items as essential to realizing the potential for improving the speed, efficiency and safety of the trade settlement process. These include two items specifically addressed in this patent application for improving the trade settlement process: 1) the development of industry matching utilities and linkages for all asset classes, and 2) standardizing reference data and moving to standardized industry protocols for broker-dealers, asset managers, and custodians. The SEC in its Mar. 11, 2004 “Concept Release: Securities Transaction Settlement” specifically requested information and comment regarding “What, if anything, should the Commission do to facilitate the standardization of reference data and use of standardized industry protocols by broker-dealers, asset managers, and custodians?”

The Final Monitoring Report of The Group of 30's Global Clearing & Settlement Committee released on May 22, 2006 stated the following “The implementation of reference data standards has proven difficult. With no global owner of reference data and friction between the needs of the domestic and cross-border market users, progress has been slow. Future progress will require greater efforts by market infrastructure operators and international institutions with global reach.”

Reference data, pervasive in the processing stream of financial transactions, is imbedded in all front, middle and back office operations and systems. Duplication of reference data and its software is common both within large financial enterprises and throughout the industry leading to significantly higher operational costs. Reference data that should be identical, within an organization and across the financial industry, are not. Being better at transactional reference data management has no strategic value—mismatching of transaction details causes transaction failures, regardless of whether one counterparty is right and the other is wrong. This alone is a compelling rationale for establishing an industry-wide utility for reference data. Also, while being better at corporate event reference data adds value by minimizing risk, the process is still quite manual and subject to interpretation, thus lending itself well to a centralized, least cost, highest quality solution as envisioned in this invention.

In general, a financial enterprise may need to access sources of corporate event information globally from: stock exchanges; central depositories; commercial data vendors; issuer prospectuses; and press releases and newspapers. This is a massive amount of information that needs to be collated, validated, captured in codes and then put into a structured syntax that can be processed by a software application. For example, there are nearly 100 different types of corporate actions, and different laws dictate how each company must report this information. As business laws across different countries are not harmonized, the rights of shareholders pursuant to an event are not the same across different markets, thus making the communication of corporate events hard to standardize globally. Additionally, this information is required for adjustments to indexes, futures, options and derivative products that have securities underlying these instruments. Also, notification of these events, culled from these numerous sources, gets passed through a long chain from issuer and registrar, and on through sub-custodians, global custodians, the Depository Trust Company & Clearing Corp. (DTCC) here in the US, other (foreign) central depositories, vendors, broker/dealers, and investment managers.

Corporate event information arrives in varied formats, is sometimes confusing to understand and at other times incorrect. Because of this each financial enterprise obtains information from multiple but different sources and matches each to the other to discover discrepancies. These discrepancies then have to be followed up on, usually through manual intervention back to the originating source, and repaired. This invention would allow for the most comprehensive sourcing of corporate event data through one facility, thus reducing the costs of using the same sources multiple times at separate facilities. The overall costs for sourcing this information would be significantly reduced, the quality of the information significantly enhanced, and the repair costs and time to correct this data minimized.

Reference data is the most synergistic, least strategically valued, least competitive technology and operational asset remaining in the financial services industry. Reference data is imbedded in other cost centers and is thus the least observable and, until now, the least funded operational component of financial enterprises. However, now identified as the single most important element of operational risk, the problems associated with reference data has become a high priority to fix.

In recognition of the pervasive impact that operational failure has on overall risk, a new regulatory initiative, organized through the Bank for International Settlements, has established a new risk regime, referred to as the Basel II Accords. Basel II is attempting to quantify, for the first time, operational risk and to mandate the set aside of significant capital to mitigate this risk. One of the key characteristics of this requirement is for financial enterprises to provide regulators with assurances that the reference data being used is consistent across the entire enterprise. Basel II has also identified outsourcing as a means to reduce risk, qualifying this statement with the notion that such risk must be contractually assumed by the outsourcing entity.

Financial transactions have, traditionally been entered into through direct negotiation between principal parties and/or their agents. While in the pre-industrial and, later, pre-information age these face to face negotiations would simultaneously result in the physical transfer of the traded goods, in later developments the goods where transferred and paid for at a later stage beyond the agreement, wherein the principals or, more likely, their agents would reference the original terms as recorded on paper records and assure the consummation of the transaction on that basis.

Historically, the failure to identify the details of a financial transaction in order to consummate, for the purchaser, the acquisition of and, for the seller, the disposition of a security was left to the visual inspection of the underlying goods, contract and/or security certificate. The expectations of the purchaser and seller or, more generally, their agents as to the value, terms and conditions of the transaction that was agreed to would be communicated to each separately by the different parties to the original negotiation. When communicated and verified by visual inspection as to it being the same, the transaction was consummated, or settled. If the details did not agree, it would be referred to as a failed transaction (or a busted trade, or an out trade, or a DK—Don't Know trade), it would be left to be investigated, later revised details conveyed to each party, and a further attempt to complete the transaction undertaken.

Throughout history until the end of the nineteenth century transactions of this nature were carried out bi-laterally, that is between two parties, first through barter transactions and then through representative collateral, such as bank notes, warehouse receipts, warrants, currencies, contracts and the like. In the US in the closing decade of the nineteenth century the Minneapolis Grain Exchange formed the first clearing association which permitted multi-party transactions first to be netted, then to be novated through means of a central counterparty, referred to as a “clearing house”. Leading up to this innovation was the progress in creating transaction standards for the underlying collateral, in this case grain, such as size of contracts, grade of grain, delivery location and delivery date. Each party to a transaction submitted the details as to number of bushels, price agreed on, date for delivery and who they transacted the agreement with (the counterparty) to the clearing house. The clearing house matched the transaction to the other side, that is, the identical but mirror image of the transaction (the buyer's transaction details matched to the seller's details). When judged as matched, thereafter, the clearing house pooled the transactions, netting down the money's owed and to be paid out to individual transactors, and the net number of contracts each retained to fulfill on, but in an obligation to the clearing house, no longer to each other. Thus the original parties to the transaction were separated from the fulfillment of the contract, with the clearing house now standing in their place.

To this day this same process is carried out, in the main, on most organized financial transaction markets, wherein transactions are standardized, parties trade, agree on price and/or quantity, submit it to a matching process, then netted, obligations of net quantity and value determined between transactors and, where central counterparties exist, novated and settled. Where no formal matching process is organized, two counterparties verify the details of the trade and await the fulfillment of same, such as when a ship container is unloaded and its contents verified by an agent against a shipping manifest. In this example and in other non centralized financial markets such as in Trade Finance, Over-the-Counter Derivatives markets or the Re-Insurance markets, standards in the form of standard bills of lading, International Swaps & Derivatives Assoc. (ISDA) contract definitions, etc. are pre-requisite to an organized, smoothly functioning market.

In the case of netting or novation systems, the dominate architectures of global clearing and settlement systems, the obligations between parties in the original transaction is separated from the parties they may be representing. As an illustration, a Brokerage Firm A acting as agent on behalf of two clients buys 1000 shares of a stock from another agent B at a price on a Stock Exchange, then acting on behalf of the second client sells 1000 shares of the same stock to the same agent at a different price. The obligation to the parties in the original transactions A & B at the Clearing House is netted to zero as to number of shares, but settles the difference of the amount (price×shares) with each other. However, party A still must receive shares from one of his clients and pay out the proceeds of the sale, and deliver shares to the other client and receive money from the purchase. These clients, in turn, may be acting on behalf of their clients as in the case of an investment manager representing mutual funds or pension funds. These mutual funds and pension funds, in turn, have agents representing their interests in keeping the records of the changing inventory of securities and moneys.

Today's highly automated financial markets require that components of the transaction, wherever in the transaction life cycle, be verified as accurate by matching both sides of a transaction to each other, and where there are mismatches on any of the critical data elements, the transaction is cycled back to its originators at the most immediate previous stage for correction and re-submission. The problem arises in that this method delay's the transaction, causing unnecessary repair work (and associated labor costs) and, where the transaction does not get repaired in sufficient time, it fails to settle. What then ensues is a loss of money to both original counterparties to the transaction. The seller has paid their client for the full value of the transaction when they have not themselves received any payment, and the purchaser must borrow the securities and pay for, then deposit it into their client's account, having not received the securities themselves from the seller.

A significant problem of systemic risk to the global financial industry is imbedded in the matching process as transactions that are entered into must await a period of time before they are finalized (actual transfer of assets take place). This period of time varies depending upon the financial product traded, the region or country traded within, and the domicile of the counterparties that traverse different market closing time zones. Failures of financial institutions between the trade date and the settlement date, specific financial transactions that are unresolved at settlement day, and fraudulent trades have all occurred due to the lack of timeliness of settlement. All financial transaction markets have a goal of shortening the settlement cycles with a vision toward simultaneous, near real-time trading and settlement.

Prior to automated matching, financial transaction data was printed out, visually checked against original source documents (manually annotated forms), and telephonically or through inspection of faxes (previously telexes) matched with counterparties' similarly sourced information. Today, through automated matching, when details of a transaction do not match, costly exception processing routines are followed, some automated, many manual.

Similarly, product inventory adjustments (due to corporate actions), and dividends and interest payments are increasingly being automated. Complicating these events is the voluntary nature of some of them, necessitating interactive communication with the ultimate inventory holder, before action can be affected. Owing to the fact that these corporate directives are usually published, unstructured, via a press release or regulatory filing, and then interpreted through independently sourced reference data intermediaries, financial enterprises occasionally receive erroneous adjustment information or payments that they then apply to their product inventory. In some instances such events are completely missed or go unreported.

This invention uniquely identifies the problem of mismatched and failed transactions at its source, it being the earliest point in the assemblage of a financial transaction. All other solutions, existing and proposed begin the matching process at a later stage when a financial transaction has already entered the mainstream of existing order entry, trading, matching, netting, clearing and settlement systems. Prior to this invention there was only the recognition of validating a transaction through a matching process wherein two interacting participants in the transaction assembled intentionally equivalent but not necessarily equal components of a financial transaction. No prior art exists wherein the reference data components of the financial transaction are first matched with a single intermediating and risk mitigating source and thereafter accepted as matched among counterparties and/or within the national (and global) clearing and settlement systems. The first recognition of a matching process that flowed automatically from order entry, trading and clearing (the Wagner U.S. Pat. No. 4,903,201, February 1990, Wagner) assumed both sides of the transaction were sourced from the same data base of reference data, that which was included in the trading system of that invention. However, the order routing, order management, trade reporting and all other external systems that interfaced into the trading and clearing systems of the Wagner invention was assumed to be accessing their own reference data, separately sourced and maintained, thus creating potential mismatches and failed transactions prior to and after the transaction entered and left the trading and clearing system, thus thwarting the potential for straight-through-processing.

Also, the nature of trading is that the initial matched transactions between trading participants must be further matched along the supply chain of agents and beneficial owners, each step in that chain having its own access to separately sourced reference data requiring further matching processes and potential for mismatches and transaction failures. The Thomson Patent (U.S. Pat. No. 5,497,317, March, 1996, Hawkins, et al) recognized the importance of centralizing the further validation of Notice of Execution and Allocation financial transactions through the matching of these transactions as incremental reference data components were added along the supply chain. However, the validation process, being later in the transaction life cycle, added potential for mismatches, and their repair procedures, into the transaction flow. While an improvement in anticipating transaction failures prior to settlement, there was no assurance that the transaction would be repaired in time to prevent failure. One improvement over the prior art is that this invention moves the matching process for 70% of the data elements of financial transactions to the “front of the line” before the transaction ever enters the transaction flow, thus allowing for speeding up of the repair process and the potential for real-time trading through final settlement and the minimization of transaction failures.

This invention also uniquely recognizes the prominence of reference data to a financial transaction, whereas all existing infrastructure systems, prior to this invention have focused on the variable and transaction specific items of quantity, traded price and/or amount as the critical valued item in the financial transaction. Further, all existing or proposed solutions still retain the siloed nature of reference data, that being that there is and will continue to be differing versions of what should be identical reference data, thus presenting all infrastructure systems with the expectation that mismatches and transaction failures will occur due to faulty reference data. The IBM Patent (Patent No. 20050216416, Sep. 29, 2005, Abrams, et al) preserves and reinforces this siloed nature of reference data by specifically structuring the data by individual client and contracted vendor sets in their embodiment of a Reference Data Facility.

Also, in a preferred embodiment, this invention uniquely indemnifies any potential monetary losses due to financial transaction failures from faulty reference data as the solution involves the creation of a risk mitigation facility, not just an outsourced solution for cost reduction. In this later regard, this invention in a preferred embodiment will combine the outsourced best of breed technology coming from initial financial enterprise members as well as utilize the primary reference data that they generate or have access to.

This invention in its role as a risk mitigation entity will comprise the normal capital underpinnings, guarantee deposits and tranches of insurance typical of other industry infrastructure entities such as clearing houses, matching utilities and central securities depositories. However, in a unique role it will mitigate transaction risk due to faulty reference data at the pre-trade processing cycles whereas the others have focused on the post-trade through to settlement processing cycles. The structure of this entity will also, in a preferred embodiment, uniquely include risk models that allow for the reduction of operational risk capital required by various financial industry regulators.

### SUMMARY OF THE INVENTION

While a variety of systems and methods have evolved over the past half century to match and clear financial transactions between the post trade and pre-settlement time frames, the novel implementations inherent in this invention is a data processing system and method to match, clear and settle reference data. Further novelty is to perform such activities between the pre-trade and post trade time frame so that subsequent post-trade matching, clearing and settlement methods and systems will be less error prone and more efficient.

The invention supplies a centralized store of reference data to be used to validate financial transactions being assembled for subsequent entry into electronic order routing, order management, trading, matching, netting, clearing, settlement and delivery systems throughout the global financial industry. In a preferred embodiment it will uniquely route transactions to the central store through use of specialized content based routers (as in the Patent No. 20020150093, October, 2002, Ott et al) operating on standardized schemas (XML, FIX and others used in the financial industry), and will uniquely validate reference data and indemnify the transaction's owner should it fail to match similarly sourced reference data in any of the subsequent upstream processes. In a further embodiment of the invention such indemnification will be accomplished through the utilization of a common industry innovation, applied uniquely through this invention, that of shared liability through mutual collective guarantees between the largest members of the Reference Data Utility.

This invention un-bundles reference data from individual financial firm's operations and systems; outsources reference data acquisition, software creation and maintenance, data updating and storage to a central facility and, in a preferred embodiment, this central store will be migrated to a distributed store across the network, closest to the routers containing the most requested profiles in the network. The invention permits economies of scale for cost reduction, and reduces the risk of failed transactions which should result in a reduction in the amount of regulatory capital set aside for operational risk losses and reserve requirements.

Over time the accumulation of historical rates of failure of the plurality of reference data stored on the data storage device of this invention will be utilized, along with other risk mitigation methods, in calibrating the total capital requirements supporting this invention, the capital requirements of the membership, the guarantee deposits required of the members, the insurance types, tranches and amounts underwritten, and various other methods for assuring the risk mitigation and loss prevention objectives of this invention.

Further, this invention speeds up the process of downstream matching while providing a warranty on losses associated with trades that fail to match. This is accomplished by having each side of the transaction first matched separately against a central of store of reference data. This validated reference data will be used later in the transaction cycle along with other validated reference data (counterparty traded with and accounts traded for) for matching along with the quantity, price and, by extension, amount, which gets added to the transaction through electronic or manual means upon negotiation and execution of the trade. These reference data validation cycles may occur multiple times, as when an order is first assembled and then again when a notice of execution is received, when a confirmation is sent and matched to an affirming transaction, or when a delivery agent (custodian, clearing agent, depository, et al) is assigned to the transaction. At each of these occurrences a unique encrypted tag number is calculated and placed in a tagged field to be logged and carried along with the transaction for audit purposes in validating a warranty request on any subsequently failed transactions. Thereafter, the trade is entered into existing downstream matching, netting, clearing, novation and settlement systems and, further, on to physical collateral depositories and/or custodian/trustee or other designated acceptance and collection destinations.

### BRIEF DESCRIPTION OF THE DRAWINGS

The present invention will become more fully understood from the detailed description and the accompanying drawings and tables, wherein:

FIG. 1 is a listing of reference data elements within a financial transaction formed in accordance with preferred embodiment of the present invention with portions thereof omitted to better illustrate invention.

FIG. 2 is a schematic diagram and listing of XML and other schemas formed in accordance with preferred embodiment of the present invention with portions thereof omitted to better illustrate invention.

FIG. 3 is a schematic diagram of a Network and data store configuration of reference data invention formed in accordance with a preferred embodiment of the present invention.

FIG. 4 is a schematic diagram of a Transaction Flow—Incoming sourced data loading/updating formed in accordance with a preferred embodiment of the present invention.

FIG. 5 is a schematic diagram of a Transaction Flow—Outbound data down loading formed in accordance with an alternative embodiment of the present invention.

FIG. 6 is a schematic diagram of a Transaction Flow—Notice of Change formed in accordance with another alternative embodiment of the present invention.

FIG. 7 is a schematic diagram of a Transaction Flow—Pre-trade reference data assemblage & validation formed in accordance with another alternative embodiment of the present invention.

FIG. 8 is a schematic diagram of a Transaction Flow—Post-trade reference data retrieval/validation formed in accordance with another alternative embodiment of the present invention.

FIG. 9 is a schematic diagram of a Reporting flow of volumes and error distribution analysis, and other metrics formed in accordance with another alternative embodiment of the present invention.

TABLE is a listing of Reference metadata and Reference data elements formed in accordance with preferred embodiment of the present invention with portions thereof omitted to better illustrate invention.

### DETAILED DESCRIPTION OF THE PREFERRED EMBODIMENTS OF THE INVENTION

Reference data is attached to a transaction record at various stages in the life cycle of a transaction, currently by the selection or input of such requests by a human being, either by looking up information on a computer file of such information, if it is being entered for the first time, or through computerized access to previously prepared directories and/or financial transactions (as when someone already bought a stock and now wants to sell it). This reference data can be accessed via each business's immediate application which incorporates both the specific business rules for the particular transaction (stock trade, bond trade, futures trade, swap, credit derivative, et al) as well as the required reference data for each. Sometimes the application accesses a central store of reference data within the organization, sometimes an external store, at other times it is integrated within the business application itself.

Our invention, an industry-wide store of Reference Data and its communications infrastructure, will be used to populate all the stores of such data previously described. It would respond to all the potential requests for reference data information that each organization now makes to its own centralized and siloed reference data bases. However, the basic universe of all required data will be defined as a finite number of assets, counterparties, etc. that make up the complete universe of products and supply chain participants. Every firm now duplicates this same set of information except, sourcing it from different vendors and/or creators and applying different filtering and cleansing rules, it is never the same, thus the problems of failed transactions caused by faulty reference data.

This invention contemplates that throughout the day each assemblage of a financial transaction, whether done by a human hand on a keyboard or by an automated system, retrieves its specific set of reference data from our inventions store of reference data. As an example, envision a particular day in which there is heavy trading in IBM. Traders within many firms are accessing the symbol, Cusip No., traded market, currency, regulatory fee, etc. for each specific transaction of IBM. They are also accessing counterparty identifiers, clearing and settlement agent descriptors, and other supply chain information to clarify who they are transacting business with and on whose behalf. There are many requests within a firm and across many firms for the same information. This is the dynamics of the interactive application that is unique and supported by a specialized scalable content router with embedded XML (or other) schemas representing the content requests of all of these transactions.

The router, deployed within a distributed network, includes an algorithm that allows for content selection, content routing and load balancing. This network is built-out from single intelligent routers, each of which is capable of sharing, adjusting and re-balancing its routing loads and content selection criteria with its “next-in-line” router.

The software allows for the network to select the path that a message will follow to its destination through setting of user controlled profiles within the router which interrogates the content of an XML or other schema defined message. The user need only send his/her profile, in this case in the form of a request for specific reference data set to the nearest router. The routers talk to each other and exchanges aggregated profiles. A message/packet is distributed through the network because each router knows the interest of its neighbor routers and they know their neighbors' profile. The software dynamically adjusts the filtering between any two contiguous nodes in the network thus allowing for dynamic load balancing and scaling. Packets may travel through multiple routers and each router makes a decision on what to do with it. The routers operate within a multicast network. A message will be delivered to multiple users if it matches multiple profiles

XML, a web based messaging standard, both industry driven and vendor initiated, provides a way for programs written in different languages running on different platforms to communicate with each. Using this language, already customized for specific industry use by such industry initiatives as SWIFT, FISD, FIX, et al, it becomes practicable, for example, for main frame applications to communicate with web based services. Combined in a unique way with content enabled network routers, the technology will route reference data between a central core utility and multiple disparate financial enterprises. Reference data thus presented in standard XML format (or other schemes) can now be entered into application portfolios through the prevalent middle-ware messaging software (MQ series, Tibco, et al) now common place within all of the largest financial enterprises.

The matching of user defined profiles to the message content is done by the algorithm which operates on the entire schema for the message resident in the specialized router software. It matches an “interest profile”, that is a subset of the schema, as represented by a user controlling the selection as specified in the same schema as the message. The interest profile can be thought of as a standing query on a database, wherein the message that passes the query will be forwarded, otherwise not.

A forwarded message represents a validated string of reference data and this invention will calculate a unique encrypted tag number (in one such embodiment Tag No.=Modulus 10/11 calculation+random number), combining the bit values of reference data content with a random number, and place the resulting number in a tagged field. It will then be logged and carried along with the transaction for audit purposes in validating a warranty request on any failed transactions. Also note, that the network is schema agnostic. If end users agree on a new schema, it can be implemented immediately; nothing needs to be changed inside the network.

The software separates a message into a header and an optional “payload”. If the message is unstructured, the header contains a content descriptor; if the message is, for example, a structured XML message it can go fully into the header. The distinction between header and payload simply defines what the router uses for its routing decision.

The benefit of this solution is that the heavy lifting of selection of data is done in the network where large band-width abounds vs. either receiving all the data at the client (Server, PC or Hand-held device) and doing the filtering at that point or maintaining user profiles at a centralized server as in an ASP model. Also by raising the abstraction level of what a network can do, the cost of building and maintaining applications are greatly reduced. Previously a network could only deliver to a specific terminal address. If required to build a data centric solution, multiple layers of middle-ware are required on top of the network. This solution allows data abstraction within the network and routing directly to the application.

Secondly, in an overnight or periodic updating mode, such information as closing prices (for example every product master record is updated, there could be six million) gets stored at the central store of all reference data (our Utility) as well as in the downstream distributed data stores specific to each organization.

Finally, the central store of reference data at the industry-wide Reference Data Utility is both dynamically and periodically being updated by various suppliers and creators of the basic information of reference data. For example, a notification is received that on a certain date, Hewlett Packard will acquire Compaq, or that as of a specific date the holders of stock in Company X will now have twice the number of shares due to a 100% stock dividend, or that one dealer went out of business, or that a new futures exchange is starting up, or a new company is assigned a trading symbol and ID number, or that an exchange will be closed on a certain date, etc. Further, internally contained reference data triggers events such as in a product's master record containing information as to a conversion date and conversion rate for a bond. All such changes will be broadcast to also find its way downstream to the distributed data stores.

The above description is the first embodiment of this invention, as it would be the initial installation. However, over time, the separate downstream stores of reference data will be eliminated as more business application are written or modified to access the central store of reference data (our Utility) and the central store of information will be distributed across the network.

While there is much activity around schemas in the financial industry, the main ones we would be concerned with is the FIX and FIXML schemas, the ISITC schema, the FpML schema, and the 15022 and 20022 schemas from SWIFT. This is the prevalent format that financial transactions are being sent in messages between applications. Of course there are also many proprietary EDI's and other linkages between applications which must be accommodated in further embodiments of this invention.

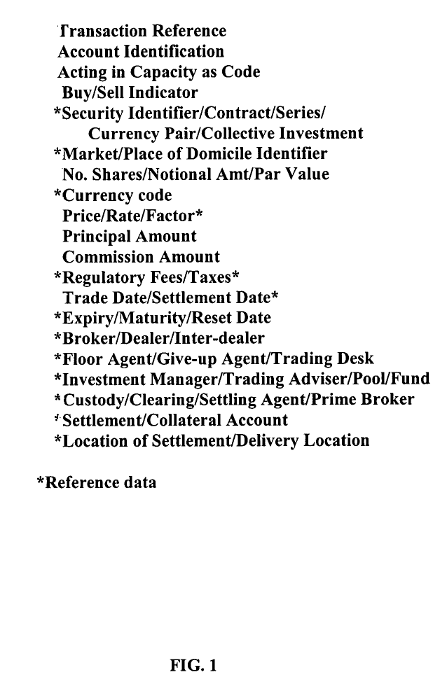

FIG. 1. Thus, in accordance with the present invention, data communication networks will be utilized to obtain sources of reference data for inclusion in the reference data matching, clearing and settlement system. Such data communication networks may be private and/or public networks that will permit the transmission of a plurality of reference data from a plurality of reference data sources. The quality of the reference data will determine the sources to be utilized, giving preference to those originating sources that are the creators of the first appearance of the data in electronic form, within the constraints of cost and timeliness. The originating sources of this data varies, depending upon its category and includes such sources, but not limited to exchanges, trading entities, trade associations, brokers, dealers, commercial vendors, aggregators, custodians, national numbering associations, and others. For example, categories of reference data include, but are not limited to product and counterparty identifiers, country codes, tax jurisdiction, commission rate, et al.

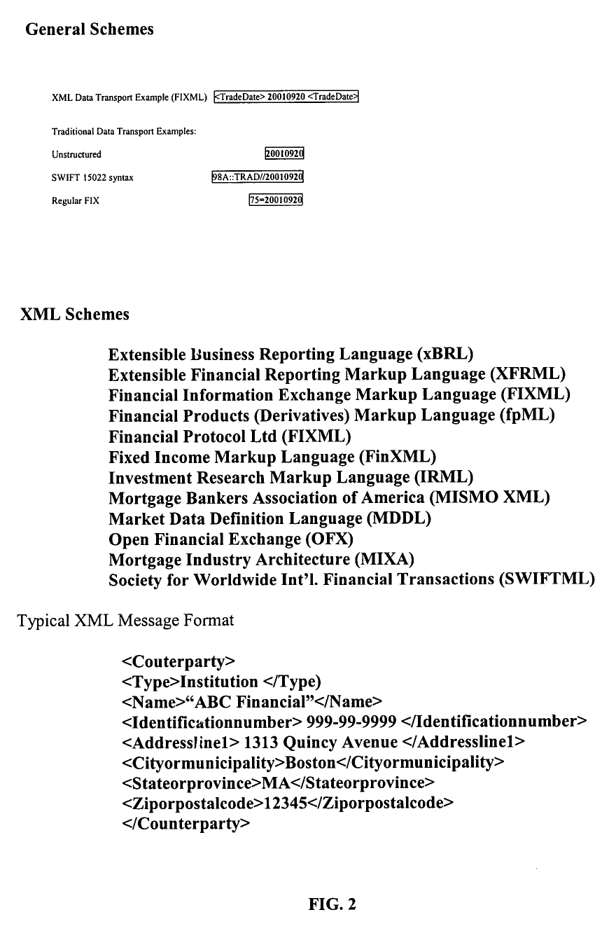

FIG. 2. The reference data content requirements for the plurality of reference data is being addressed in broad dimensions through conforming such reference data to industry standard data protocols using an communication messaging protocol referred to as Extensible Markup Language (XML) for each product category. Previous data representations for reference data had many proprietary formats. It is the intention of this invention to utilize XML languages, or other accepted schemes to represent a normalized version of all reference data content.

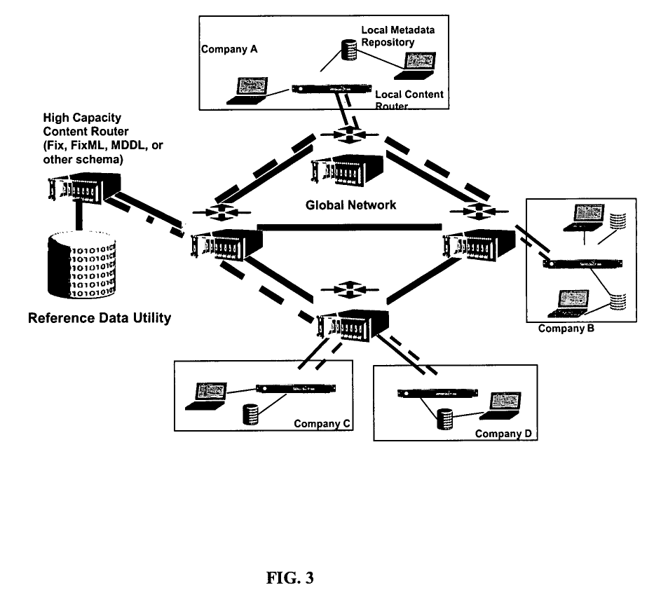

FIG. 3. XML is a way of representing data so that its content is discernable within the message or transport layer. Unlike earlier standards that primarily transported data, this standard imbeds the data's intent, or content, and structure (semantics) into the message through the use of tags. This allows for network/distributed solutions for content selection, content routing and load balancing.

XML also employs Document Type Definitions (DTDs) that allow any application to understand both the data and the context of the data. Thus, XML will play an increasingly important role in both the transmission and integration of data into applications and thus make it practicable, for example, for main frame applications to communicate with web based services.

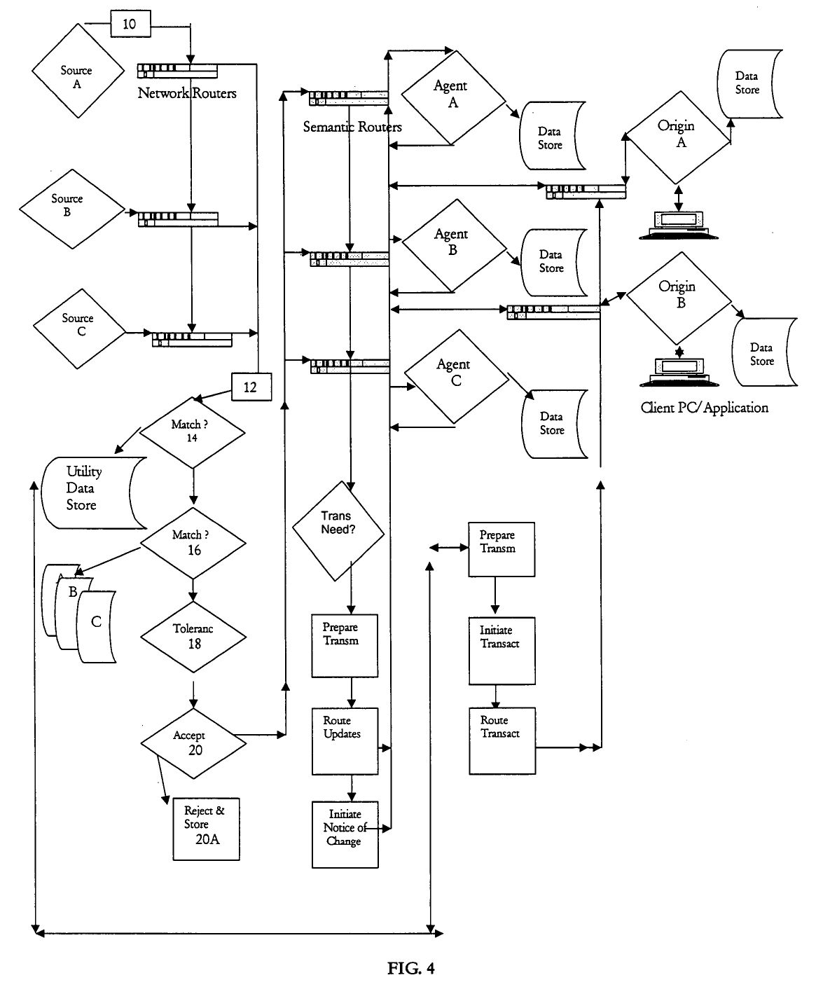

FIG. 4. Sequence 10-20A. Reference data such as valuation prices, product and counterparty codes, and other information will be sourced directly at 10. from origination parties such as exchanges, clearing houses, settlement facilities, securities depositories, electronic dealers, electronic trading networks, national numbering associations, accredited trade associations, and approved electronic distributors of such originating sources. Where additional or intermediary sources of such prices, codes and information are available, leading suppliers will be identified through established surveys, through industry acknowledged anecdotal evidence, through available repositories of historical loss data associating such losses to faulty reference data suppliers, and through statistical accumulation of failure rates of data accumulated through the data storage devices of this invention.

This invention provides methods and data storage devices for the receipt at 12. and aggregation and storage at 14. of a plurality of reference data. Such methods shall comprise at 16. matching, indexing, storage and retrieval programs, computer processing modules and data storage devices comprised of either or both internal (computer memory) and/or external storage that shall at 18. place the plurality of reference data matched, plus a calculated unique tag number, on said storage devices. Such indexing method shall maximize the speed at which data is stored and retrieved and may combine commercially available and proprietary indexing storage and retrieval methods. Such computer processing module may consist of multiply arrayed processors and/or servers operating such indexing programs. When matching is performed, various tolerance and risk checks are further performed at 20. to assure the credibility of the reference data and, if found acceptable, passed on at 22. for subsequent transmission for downstream use and/or data storage. Where either no match is found or tolerance or risk checks are breached, various reference data elements along with the sources of the information are stored for later exception reporting at 20A

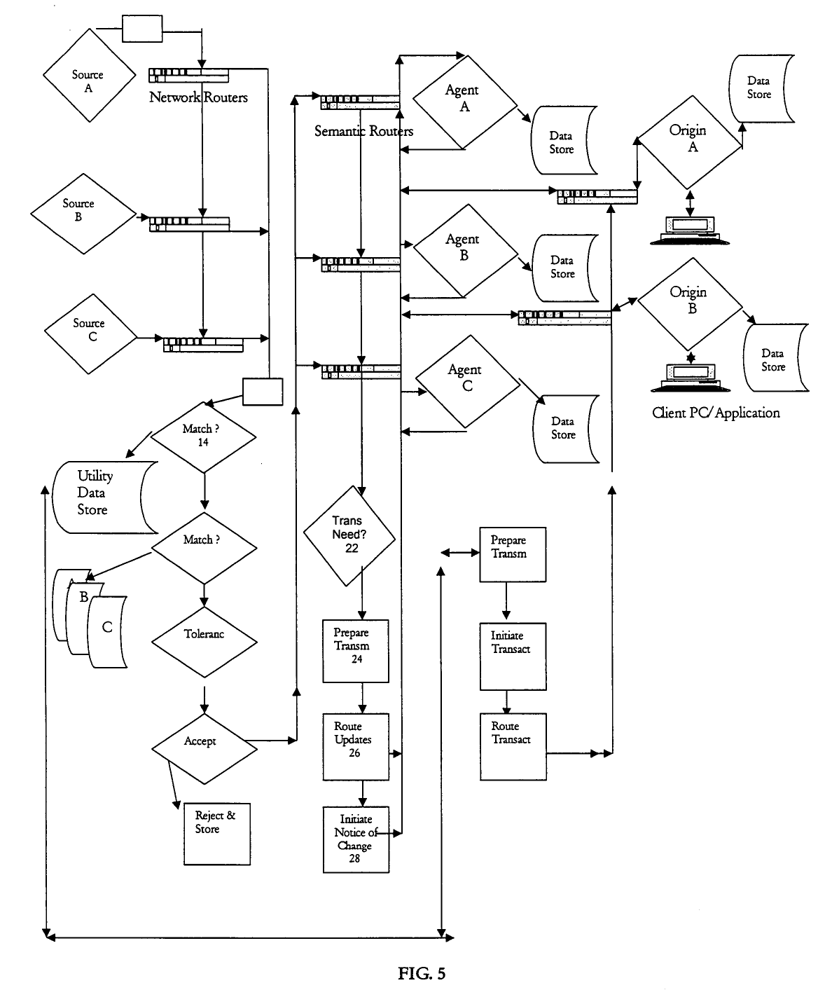

FIG. 5. Sequence 22-28. This invention further provides methods and communication devices for preparing at 22. and distributing at 24. reference data to broker-dealers, asset managers, custodians, commercial redistributors of such reference data, traders and other originators of reference data requests, and to others. Such methods and communication devices may be comprised of both commercial and proprietary networks, operating within standard network communication protocols, and may use standard and/or proprietary routers/servers and/or computer devices directly imbedded and/or overlayed on the networks at 26. to broadcast, read and/or forward messages, and to store message profiles. Such message profiles will be used for determining general or specific content to be distributed and/or verified from the computer storage devices storing a plurality of reference data to broker-dealers, asset managers, custodians, and other users and commercial redistributors of reference data, whether individually or collectively. Such profiles may consist of data arrayed as XML schemas, XML DTD's, SQL queries, Java scripts, and other content and/or computational profiling arrangements, both standard and proprietary. Notice of change messages at 28. are structured with newly updated reference data and prepared for downstream transmission.

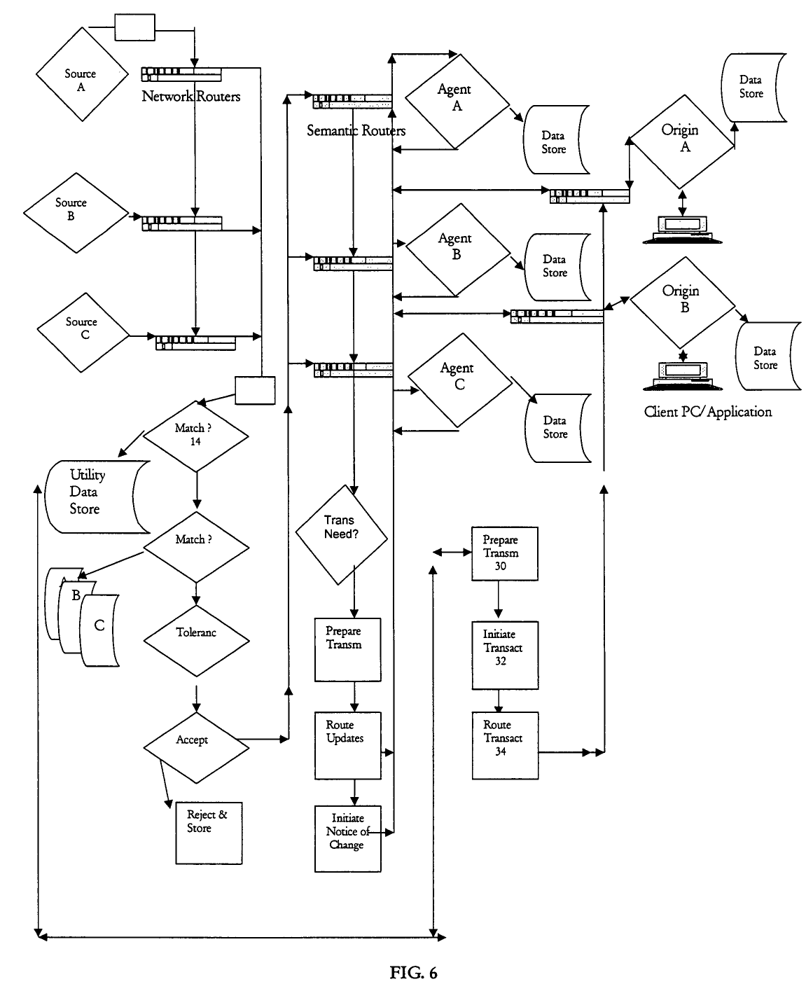

FIG. 6. Sequence 30-34. This invention provides methods and communication devices for distributing new and/or updated reference data to broker-dealers, asset managers and custodians, to commercial redistributors of such reference data, and to others.

Such methods and communication devices may be comprised of both commercial and proprietary networks, operating within standard network communication protocols, and may use standard and/or proprietary routers/servers and/or computer devices directly imbedded and/or overlayed on the networks at 30. to broadcast, read and/or at 32. forward messages, and to update and store message profiles at 34. Such message profiles will be used for determining general or specific content to be distributed from the computer storage device storing a plurality of reference data to broker-dealers, asset managers, custodians, and other users and commercial redistributors of reference data, whether individually or collectively. Such profiles may consist of data arrayed as XML schemas, XML DTD's, SQL queries, Java scripts, and other content and/or computational profiling arrangements, both standard and proprietary

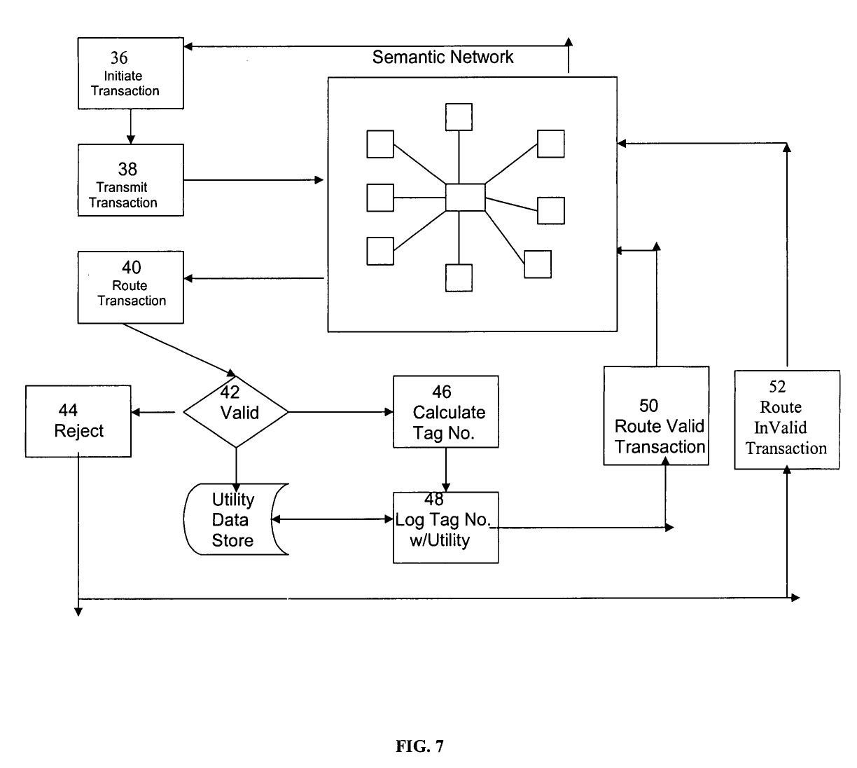

FIG. 7. Sequence 36-52. This invention provides methods and communication device for broker-dealers, asset managers, custodians and others to communicate with the computer storage devices a sub set of reference data now contained within pre-trade configured financial transactions

Such methods and communication devices may be comprised of both commercial and proprietary networks, operating within standard network communication protocols, and may use standard and/or proprietary routers/severs and/or computer devices directly imbedded and/or overlayed on the networks at 36. to broadcast and/or at 38. forward messages, and at 40. to update and store message profiles. Such message profiles will be created by broker-dealers, asset managers, custodians, and other users and commercial redistributors of reference data, for determining general or specific content, as contained within pre-trade configured financial transactions, to be matched to the computer storage devices storing a plurality of reference data. Such profiles may consist of data arrayed as XML schemas, XML DTD's, SQL queries, Java scripts, and other content and/or computational profiling arrangements, both standard and proprietary

This invention further provides methods and computer processing modules at 42. for matching reference data contained within pre-trade configured financial transactions received from broker-dealers, asset managers and custodians to the aggregated plurality of reference data stored on data storage devices

Such methods shall comprise computer processing modules containing indexing and retrieval programs which constructs an index from the reference data contained within the pre-trade configured financial transactions, and accesses the previously stored reference data, such reference data stored on data storage devices comprised of both internal (computer memory) and/or external storage based upon the same indexing methods. Such retrieval and indexing methods shall maximize the speed at which data is accessed and retrieved and may combine commercially available and proprietary indexing storage and retrieval methods. Such computer processing module may consist of multiply arrayed processors and/or servers operating such indexing programs.

Such methods and computer processing modules shall further consist of an area in computer memory where the retrieved reference data accessed from the plurality of reference data stored on the computer storage devices is matched to the reference data contained within the pre-trade configured financial transactions.

Where at 44. the data does not match no retrieval will be available and the computer processing module will store an indicator that no match has occurred. Where no match has occurred, the computer processing modules will attempt to match each component of the plurality of reference data stored on the computer storage devices, based upon a predetermined sequence of the individual reference data elements contained in the pre-trade configured financial transactions (see Table).

Where matches do occur a tag number at 46. will be calculated and at 48. logged with the utility, and the validated, matched pre-trade configured transactions with all requested and validated reference data will be routed at 50. to the originator of the transaction.

A further objective is to provide methods and communication devices at 52. for distributing a notice of mismatched pre-trade configured financial transactions back to broker-dealers, asset managers, custodians and others.

Such methods and communication devices may be comprised of both commercial and proprietary networks, operating within standard network communication protocols, and may use standard and/or proprietary routers/servers and/or other computer devices directly imbedded and/or overlayed on the networks to broadcast, read and/or forward messages, and to update and store message profiles. Such message profiles will be created by broker-dealers, asset managers, custodians, and other users, for determining general or specific content, as contained within pre-trade configured financial transactions, for error messages to be forwarded to broker-dealers, asset managers, custodians, and others. Such profiles may consist of data arrayed as XML schemas, XML DTD's, SQL queries, Java scripts, and other content and/or computational profiling arrangements, both standard and proprietary.

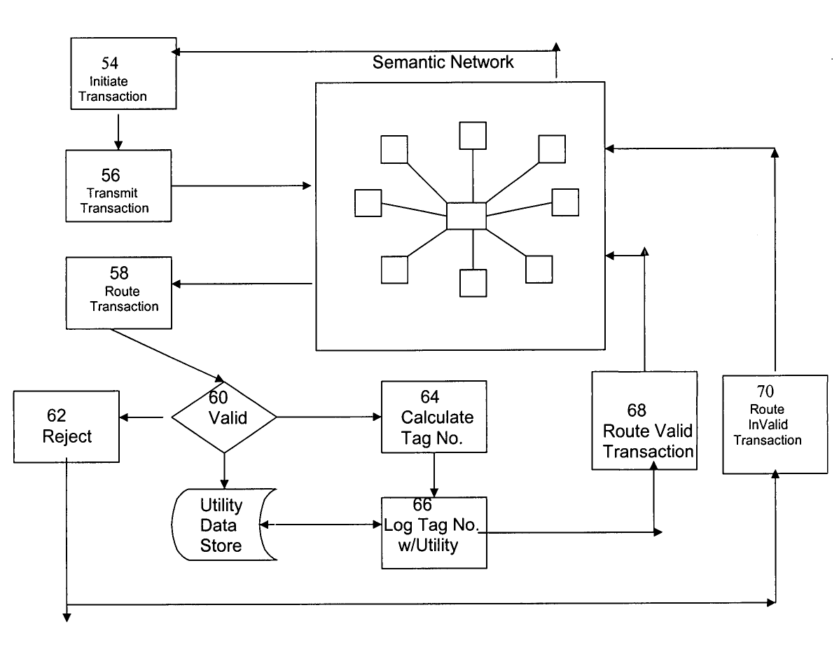

FIG. 8. Sequence 54-70. This invention further provides methods and communication devices for broker-dealers, asset managers, custodians and others to communicate with computer storage devices a sub set of reference data now contained within post-trade financial transactions

Such methods and communication devices may be comprised of both commercial and proprietary networks, operating within standard network communication protocols, and may use standard and/or proprietary routers/servers and/or computer devices directly imbedded and/or overlayed on the networks at 54. to broadcast and/or at 56. forward messages, and at 58. to update and store message profiles. Such message profiles will be created by broker-dealers, asset managers, custodians, and other users and commercial redistributors of reference data, for determining general or specific content, as contained within post-trade financial transactions, to be matched to computer storage devices storing a plurality of reference data. Such profiles may consist of data arrayed as XML schemas, XML DTD's, SQL queries, Java scripts, and other content and/or computational profiling arrangements, both standard and proprietary

This invention further provides methods and computer processing modules for matching reference data contained within post-trade financial transactions received from broker-dealers, asset managers and custodians to the aggregated plurality of reference data stored on data storage devices

Such methods shall comprise computer processing modules containing an indexing and retrieval program which constructs an index from the reference data contained within the post-trade financial transactions, and accesses the previously stored reference data, such reference data stored on data storage devices comprised of both internal (computer memory) and/or external storage based upon the same indexing method. Such retrieval and indexing method shall maximize the speed at which data is accessed and retrieved and may combine commercially available and proprietary indexing storage and retrieval methods. Such computer processing modules may consist of multiply arrayed processors and/or servers operating such indexing programs.

Such methods and computer processing modules shall further consist of an area in computer memory where the retrieved reference data accessed from the plurality of reference data stored on the computer storage devices is matched to the reference data contained within the post-trade financial transactions.

Where at 60. matches do occur a tag number at 64. will be calculated and at 66. logged with the utility, and the validated, matched post-trade transaction with all requested and validated reference data will be routed at 68. to the originator of the transaction.

Where the data does not match at 60. no retrieval will be available and the computer processing module will at 62. store an indicator that no match has occurred. Where no match has occurred, the computer processing module will attempt to match each component of the plurality of reference data stored on the computer storage devices, based upon a predetermined sequence of the individual reference data elements contained in the post-trade financial transactions. (See Table)

A further objective is to provide a method and communication devices for distributing at 70. a notice of mismatched post-trade financial transactions back to broker-dealers, asset managers, custodians and others.

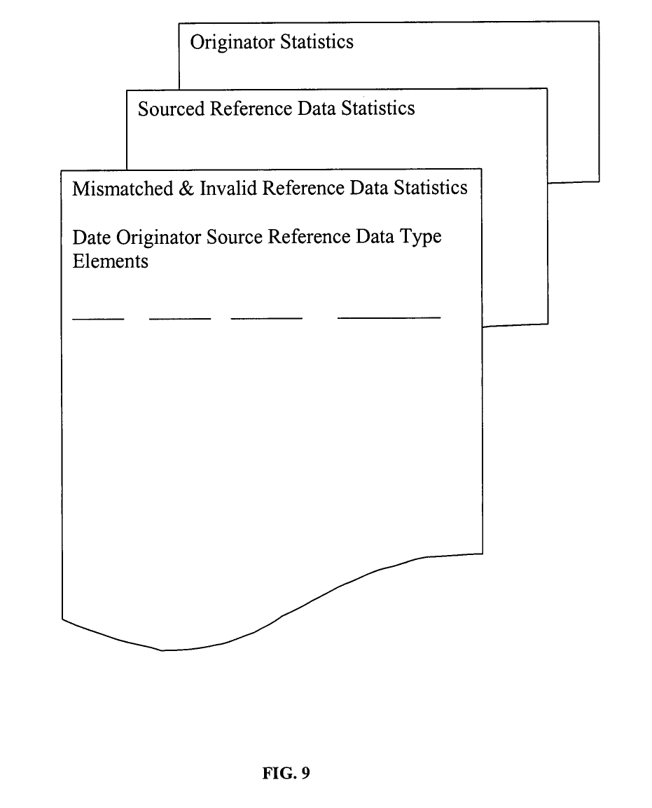

Such methods and communication devices may be comprised of both commercial and proprietary networks, operating within standard network communication protocols, and may use standard and/or proprietary routers/servers and/or computer devices directly imbedded and/or overlayed on the network(s) to broadcast, read and/or forward messages, and to update and store message profiles. Such message profiles will be created by broker-dealers, asset managers, custodians, and other users, for determining general or specific content, as contained within post-trade financial transactions, for error messages to be forwarded to broker-dealers, asset managers, custodians, and others. Such profiles may consist of data arrayed as XML schemas, XML DTD's, SQL queries, Java scripts, and other content and/or computational profiling arrangements, both standard and proprietary FIG. 9. It is a still a further objective to provide methods to record the occurrence, frequency, reason and resolution of mismatched pre-trade and post-trade financial transactions.

Such methods shall consist of both computerized and manual means to record, store analyze, and report on the occurrence and detail of each mismatched pre-trade and post-trade financial transaction. Such reporting shall be in the aggregate, by individual reference data element, by reference data category, and by individual broker-dealer, asset-manager, custodian and other supply chain participants.

It is a final objective to provide methods to record the volume, frequency and occurrence of sourced reference data and pre-trade and post-trade financial transactions, and other metrics and statistics that might be required over time.

Such methods shall consist of both computerized and manual means to record, store analyze, and report on the occurrence and detail of each sourced reference data element, and the occurrence and detail of each pre-trade and post-trade financial transaction. Such reporting shall be in the aggregate, by individual reference data element, by reference data category, and as new categories are required; and by individual originator of reference data, broker-dealer, asset-manager, custodian and other supply chain participants and others as may be required.

One skilled in the art will appreciate that the present invention can be practiced by other than the described embodiments, which are presented for purposes of illustration and not of limitation, and the present invention is limited only by the claims

What is claimed is:

1. A Reference Data Utility comprising a method and apparatus that sources, receives, aggregates, normalizes, stores, updates, distributes and reports on reference data for financial transactions in the investment and capital markets, such method and apparatus comprising the steps of:
obtaining reference data from originating sources, such sources to include, but be not limited to exchanges, trading entities, trade associations, brokers, dealers, commercial vendors, aggregators, custodians, national numbering associations, and other supply chain participants
conforming such reference data to a normalized representation
providing a method and data storage device for the aggregation and storage of a plurality of reference data, represented in both normalized form and in a form made available by originating sources
providing a method and communication device for distributing such reference data to broker-dealers, asset managers and custodians, to commercial redistributors of such reference data, and to other supply chain participants
providing a method and communication device for distributing externally sourced updates to such reference data to broker-dealers, asset managers and custodians, and to commercial redistributors of such reference data, and to other supply chain participants
providing a method and communication device for distributing internally sourced updates to such reference data to broker-dealers, asset managers and custodians, and to commercial redistributors of such reference data, and to other supply chain participants
providing a method and communication device for distributing internally triggered updates to such reference data to broker-dealers, asset managers and custodians, and to commercial redistributors of such reference data, and to other supply chain participants

2. A Reference Data Utility comprising a method that assures its members' losses from failures of financial transactions due to faulty reference data.

3. A Reference Data Utility comprising a method that conforms reference data to standards of timeliness, completeness, and accuracy within predetermined risk tolerances.

4. A further claim of a Reference Data Utility comprising a method that normalizes reference data for financial transactions in the investment and capital markets as in claim 1, such method to conform the normalized representation of reference data to industry standard data schemas.

5. A further claim of a Reference Data Utility comprising a method and apparatus that allows for pre-trade configured financial transactions to communicate with the data storage device of this invention, such method and apparatus comprising the steps of providing:
a method and communication device for broker-dealers, asset managers, custodians and other supply chain participants to communicate with the computer storage device, such communication comprising a sub-set of reference data contained within pre-trade configured financial transactions
a method and computer processing module for matching reference data contained within pre-trade configured financial transactions received from broker-dealers, asset managers and custodians, and other supply chain participants, to the aggregated plurality of reference data stored on a data storage device
a method and computer processing module to match the reference data contained within pre-trade configured financial transactions to the normalized reference data stored on the data storage device

6. A further claim of a Reference Data Utility comprising a method and computer processing module that records and communicates the occurrence, frequency, and reason of mismatched pre-trade configured financial transactions, such method and apparatus comprising the steps of providing:
a method and computer processing module to determine the occurrence of a mismatch, and the specific reference data that did and did not match
a method and computer storage device to record the occurrence of a mismatch, and the specific reference data that did and did not match
a method and communication device for distributing a notice of mismatched pre-trade configured financial transactions back to broker-dealers, asset managers, custodians and other supply chain participants

7. A further claim of a Reference Data Utility comprising a method and apparatus that allows for post-trade configured financial transactions to communicate with the data storage device of this invention, such method and apparatus comprising the steps of providing:
a method and communication device for broker-dealers, asset managers, custodians and other supply chain participants to communicate with the computer storage device, such communication comprising a sub-set of reference data contained within post-trade configured financial transactions
a method and computer processing module for matching reference data contained within post-trade configured financial transactions received from broker-dealers, asset managers and custodians, and other supply chain participants, to the aggregated plurality of reference data stored on a data storage device
a method and computer processing module to match the reference data contained within post-trade configured financial transactions to the normalized reference data stored on the data storage device

8. A further claim of a Reference Data Utility comprising a method and computer processing module that records and communicates the occurrence, frequency, and reason of mismatched post-trade configured financial transactions, such method and apparatus comprising the steps of providing:
a method and computer processing module to determine the occurrence of a mismatch, and the specific reference data that did and did not match
a method and computer storage device to record the occurrence of a mismatch, and the specific reference data that did and did not match
a method and communication device for distributing a notice of mismatched post-trade configured financial transactions back to broker-dealers, asset managers, custodians and other supply chain participants

9. A further claim of a Reference Data Utility comprising a method and apparatus that allows for the originators of both pre-trade and post trade financial transactions to communicate between a data origination device and a data storage device, such method and apparatus comprising the steps of providing:
a method and communication device for broker-dealers, asset managers, custodians and other supply chain participants to communicate with the computer storage device, such communication comprising a sub-set of reference data contained within network computing devices
a method and communication device for broker-dealers, asset managers, custodians and other supply chair participants to communicate with the computer storage device, such communication comprising a next-in-line network address contained within network computing devices for both the data origination device and the data storage device
a method and computer processing module to aggregate sub-sets of reference data received from originators of both pre-trade and post trade financial transactions, thus forming aggregate profiles to communicate with the computer storage device
a method and computer processing module for aggregate profiles to retain a next-in-line network addresses within network computing devices for both the data origination device and the data storage device

10. A further claim of a Reference Data Utility comprising a method and apparatus conforming reference data to standards of timeliness, completeness, and accuracy within predetermined risk tolerances as in claim 3, such method and apparatus comprising the steps of providing:
a method and computer processing module to calculate a unique encrypted tag number combining the values of certain reference data contained within financial transactions with a random number
a method and storage device to place the resulting number in a tagged field within financial transactions
a method and communication device to communicate the resulting tagged field within financial transactions back to the originators of such financial transactions
a method and computer processing module to retrieve such transactions from computer storage device for audit purposes and/or in validating a warranty request on any failed or mismatched transactions.

11. A further claim as in claim 10 wherein said unique encrypted tag number is calculated on all reference data internally and/or externally sourced that changes on a regular frequency such reference data comprising for example daily valuation prices and monthly calendar updates.

12. A further claim as in claim 10 wherein said unique encrypted tag number is calculated on all reference data that changes on an intermittent basis internally and/or externally sourced such reference data comprising for example change to codes describing merging corporate entities and changes to the terms and conditions of a corporate action.

13. A further claim as in claim 10 wherein said unique encrypted tag number is calculated on all reference data that that is generated from arriving at internal dates checked against the normalized reference data stored on the data storage devices on some periodic basis such reference data comprising for example notification of a record date for a dividend and notification of a maturity date of a bond.

14. A further claim of this invention is to report to exchanges, trading entities, trade associations, brokers, dealers, commercial vendors, aggregators, custodians, national numbering associations, and other supply chain participants statistics and other metrics on the occurrence, frequency, reason and resolution of matched and mismatched reference data from originally sourced reference data, and from pre-trade and post-trade financial transactions both matched and attempted to be matched to the plurality of reference data stored on the data storage device of this invention.

15. A further claim of this invention comprising a method that conforms reference data to standards of timeliness, completeness, and accuracy within predetermined risk tolerances as in claim 3 said method consisting of calculating accumulated failure rates and evaluating probabilities of transaction failures using for example stochastic probability measures.

16. A further claim of a Reference Data Utility comprising a method that assures its members' losses from failures of financial transactions due to faulty reference data as in claim 2 said method accomplished through the provisioning of capital reserves.

17. A further claim of a Reference Data Utility comprising a method that assures its members' losses from failures of financial transactions due to faulty reference data said method accomplished through the provisioning of capital reserves as in claim 16, said capital reserves to be calculated based upon capital standards that may apply based upon the headquarter domicile of said Reference Data Utility.
